(19) United States
(12) Patent Application Publication
(10) Pub. No.: US 2026/0178789 A1
(43) Pub. Date: Jun. 25, 2026

(54) REAL-TIME SIMULATION AND MODEL PREDICTION METHOD FOR WIRE ARC ADDITIVE MANUFACTURING BASED ON EVENT SEQUENCES

(71) Applicants: Shaoxing University, Shaoxing (CN); ZHEJIANG PROVINCE INSTITUTE OF ARCHITECTURAL DESIGN AND RESEARCH, Hangzhou (CN)

(72) Inventors: Zhen WANG, Shaoxing (CN); Yang ZHAO, Shaoxing (CN); Youdi Yuan, Shaoxing (CN); Xuelin YANG, Shaoxing (CN); Haochuan QU, Shaoxing (CN); Jun YE, Shaoxing (CN); Xinmiao YU, Shaoxing (CN); Zhi DING, Shaoxing (CN)

(21) Appl. No.: 19/421,590

(22) Filed: Dec. 16, 2025

(30) Foreign Application Priority Data
Dec. 20, 2024 (CN) 202411891997.4

(51) Int. Cl. G06F 30/17

(52) U.S. Cl. CPC G06F 30/17

(57) ABSTRACT

The present application relates to a real-time simulation and model prediction method for wire arc additive manufacturing based on event sequences, including: in the real-time process of wire arc additive manufacturing of metal structures, activating elements in real time through event sequences and guiding the heat source in real time; setting heat source model parameters, thermal simulation parameters and mechanical simulation parameters to perform real-time thermal-mechanical coupling simulation of wire arc additive manufacturing; establishing a simplified calculation theoretical model of the residual stress field and correcting the calculation model prediction.

### CROSS-REFERENCE TO RELATED APPLICATIONS

The present application claims priority to Chinese Patent Application No. 202411891997.4, filed Dec. 20, 2024, the entire disclosure of which is incorporated herein by reference.

### TECHNICAL FIELD

The present application relates to the technical field of additive manufacturing, and more particularly, to a real-time simulation and model prediction method for wire arc additive manufacturing based on event sequences.

### BACKGROUND

With the continuous advancement of modern intelligent manufacturing technology, Wire Arc Additive Manufacturing (WAAM), as an innovative process integrating traditional welding technology and modern additive manufacturing technology, has gradually become a research hotspot in the field of metal additive manufacturing due to its high material utilization rate and excellent workpiece forming capability.

WAAM technology melts metal wires through an arc heat source and forms complex metal structural components by layer-by-layer deposition. During the WAAM process, the movement of the heat source and the rapid heating and cooling of materials lead to complex thermal-mechanical behaviors, which in turn affect the forming quality and material mechanical properties of the structural components. Currently, methods such as heat treatment and high-pressure rolling are generally used to improve the mechanical properties of formed structural components. However, due to the high cost and complex processes of these methods, they still face numerous challenges when applied to the preparation of large-sized complex metal structural components. Therefore, it is particularly crucial to effectively control the defects of formed structural components during the WAAM process. Moreover, the high heat input during the WAAM process often causes various temperature-related defects in the formed metal structural components, such as pores, microcracks, residual stress, and shape distortion. The generation of residual stress and deformation in the formed structural components is mainly caused by the constraint on the thermal expansion and contraction of the additive part, which is directly related to the mechanical properties of the final formed structural components. Therefore, researching and predicting the thermal-mechanical behaviors during the WAAM process to improve forming quality and reduce the impact of defects is of great significance.

Existing research on the thermal-mechanical behaviors during the WAAM process is mainly carried out based on experiments, including residual stress and deformation measurement, fatigue crack propagation behavior, etc. However, experimental research is usually time-consuming and labor-intensive, it is relatively difficult to extract stress at certain special positions, and real-time monitoring of changes in stress distribution during the WAAM process is not feasible.

### SUMMARY

The objective of the present application is to address the deficiencies of the related art and provide a real-time simulation and model prediction method for wire arc additive manufacturing based on event sequences.

In a first aspect, the present application provides a real-time simulation and model prediction method for wire arc additive manufacturing based on event sequences, including:
S1. in a real-time process of wire arc additive manufacturing of metal structures, activating elements in real time through event sequences and guiding a heat source in real time; wherein the event sequences are used to set a virtual cube to move in three-dimensional space along a preset path and time, and apply an influence of a three-dimensional field on the path passed by the virtual cube;
S2. setting heat source model parameters, thermal simulation parameters and mechanical simulation parameters based on an event sequence method in S1, and performing real-time thermal-mechanical simulation of wire arc additive manufacturing; and
S3. establishing a simplified calculation theoretical model of a residual stress field based on a stress diffusion distribution and a correction deviation of a normal stress interface obtained from a real-time thermal-mechanical coupling simulation in S2, and correcting a calculation model prediction.

In one embodiment, S1 includes:
S101. using the event sequences to restore the real-time process of wire arc additive manufacturing, and activating the elements on the path swept by the virtual cube of the event sequences one by one; and
S102. taking a position of the virtual cube in the event sequences as a moving heat source position for guidance, and adopting a Goldak double ellipsoid heat source model.

In one embodiment, S2 includes:
S201. performing thermal simulation parameter setting and mechanical simulation parameter setting, and construct a thermal-mechanical coupling simulation model; wherein the thermal simulation parameter setting includes a setting of thermal boundary conditions, latent heat of phase change, thermal conductivity and specific heat, and the mechanical simulation parameter setting includes a setting of thermal expansion coefficient, material mechanical parameters and boundary mechanical constraints; and
S202. constructing a linear deposition simulation model to simulate a multi-layer and multi-pass deposition process of wire arc additive manufacturing, and obtaining a stress diffusion distribution of a deposited layer according to deposition stress simulation results.

In one embodiment in S202, the linear deposition simulation model includes a single-line deposition simulation model, a double-line deposition simulation model and a three-line deposition simulation model;
in the single-line deposition simulation model, an additive deposited layer is placed in a middle of a substrate;
in the double-line deposition simulation model, additive deposited layers are placed on longitudinal edges on both sides of the substrate; and
in the three-line deposition simulation model, additive deposited layers are placed on the longitudinal edges on both sides and a middle of the substrate.

In one embodiment, S3 includes:
S301. establishing a simplified calculation theoretical model, which is composed of the substrate and an additive part in an wire arc additive manufacturing process, comprising a stress field distribution before a release of fixture constraints and a stress field distribution after the release of fixture constraints; at a junction of the additive part and the substrate, there is a diffusion effect of deposition stress before and after the release of fixture constraints, which presents a semicircular shape;
S302. correcting the calculation model prediction, comprising:
S3021. for an integral component with a T-shaped cross-section composed of the substrate and the additive part, calculating centroid heights yₛ, y_{d} and y₀ of the substrate, a deposited wall and an integral component;
S3022. calculating a moment of inertia Iₓₓ of a T-shaped cross-section;
S3023. before the release of fixture constraints on the substrate, calculating an equivalent concentrated force F_{d} caused by a deposition stress σ_{zz} on the substrate during the wire arc additive manufacturing process and a pressure Fₛ in the substrate;
S3024. before the release of fixture constraints on the substrate, calculating a bending moment M around a neutral axis generated by a positional offset between the equivalent concentrated force F_{d} and the pressure Fₛ in the substrate;
S3025. after the release of fixture constraints on the substrate, calculating a deformation curvature κ of the calculation model;
S3026. after the release of fixture constraints on the substrate, calculating a corrected residual stress field σ_{zz,res}(y) considering a normal stress interface correction deviation Δy′ during an entire wire arc additive manufacturing process;

$${σ}_{zz , res} ( y ) = {σ}_{zz} + \frac{M}{{I}_{xx}} \times ( y - Δ {y}^{′} ) ;$$

wherein y=0 is located at a height of the neutral axis y₀; Δy′ is a correction deviation of a normal stress interface caused by a stress diffusion of the deposited layer, and the correction deviation is only for a part where the longitudinal stress is “positive”, i.e., a tensile stress zone, while a compressive stress zone of the substrate remains unchanged;
S3027. calculating a descending gradient

$$\frac{{Δσ}_{zz}}{Δ y}$$

of the residual stress field.

In a second aspect, there is provided a real-time simulation and model prediction system for wire arc additive manufacturing based on event sequences, for executing any one of the methods in the first aspect, including:
an activation and guidance module, configured for in a real-time process of wire arc additive manufacturing of metal structures, activating elements in real time through event sequences and guiding a heat source in real time; wherein the event sequences are used to set a virtual cube to move in three-dimensional space along a preset path and time, and apply an influence of a three-dimensional field on the path passed by the virtual cube;
a simulation module, configured for inputting heat source model parameters, thermal simulation parameters and mechanical simulation parameters corresponding to the activation and guidance module, and performing real-time thermal-mechanical simulation of wire arc additive manufacturing; and
a prediction module, configured for inputting a stress diffusion distribution and a real-time thermal-mechanical coupling simulation obtained by the simulation module, and establishing a simplified calculation theoretical model, and correcting a calculation model prediction.

In a third aspect, there is provided a computer storage medium, wherein a computer program is stored in the computer storage medium; when the computer program is run on a computer, the computer is caused to execute any one of the methods in the first aspect.

In a fourth aspect, there is provided an electronic device, comprising:
a memory, configured to store a computer program;
a processor, configured to execute the computer program to implement any one of the methods in the first aspect.

The beneficial effects of the present application are as follows:
1. The present application adopts an event sequence approach to perform real-time simulation of the wire arc additive manufacturing process, significantly reducing the modeling difficulty. Element activation no longer relies on an extremely large number of analysis steps; instead, element activation can be performed along with the event sequence in a single analysis step, effectively reducing operational complexity. Through the definition of event sequences, complex path planning can be achieved only by providing position coordinates and time information, making it easier to simulate the wire arc additive manufacturing process of curved weld beads or special-shaped structural components.
2. The present application considers the stress diffusion distribution caused by repeated thermal input at the junction of the additive part and the substrate, corrects and predicts the theoretical calculation of residual stress during the wire arc additive manufacturing process, and effectively improves the real-time prediction accuracy of the model.
3. The present application realizes the simulation of multi-layer and multi-pass deposition with high temperature and high speed in wire arc additive manufacturing application scenarios by activating elements and guiding the heat source through event sequences, obtains the stress diffusion effect caused by repeated thermal input at the junction of the additive part and the substrate of different materials through real-time thermal-mechanical simulation of wire arc additive manufacturing, and achieves efficient, real-time and accurate prediction of deposition stress and deformation during the wire arc additive manufacturing process through the corrected prediction of the theoretical calculation of residual stress of the integral wire arc additive manufacturing component with a T-shaped cross-section considering the stress diffusion effect.

### BRIEF DESCRIPTIONS OF THE DRAWINGS

FIG. 1 is a schematic diagram of the overall flow of the real-time simulation and model prediction method for wire arc additive manufacturing based on event sequences according to the present application.

FIG. 2 is a schematic diagram of event sequence-controlled element activation and moving heat source simulation.

FIG. 3a is a schematic diagram of the molten pool morphology of the double ellipsoid heat source model.

FIG. 3b is a schematic diagram of the geometric parameters of the molten pool of the double ellipsoid heat source model.

FIG. 4 is a schematic diagram of the thermal boundary conditions of the integral component model with a T-shaped cross-section.

FIG. 5a is a schematic diagram of the cross-sectional stress field of the single-line deposition simulation model.

FIG. 5b is a schematic diagram of the cross-sectional stress field of the double-line deposition simulation model.

FIG. 5c is a schematic diagram of the cross-sectional stress field of the three-line deposition simulation model.

FIG. 6a is a schematic diagram of the fixture constraints of the single-line deposition simulation model.

FIG. 6b is a schematic diagram of the narrow channel constraints in the middle of the single-line deposition simulation model.

FIG. 7 is a schematic diagram of the temperature field of the single-line deposition simulation model during the printing process (Unit: ° C.).

FIG. 8 is a schematic diagram of the residual stress development before and after the release of fixture constraints during the wire arc additive manufacturing process.

FIG. 9 is a schematic diagram of the stress diffusion of the deposited layer before and after the release of fixture constraints for the integral component model with a T-shaped cross-section.

FIG. 10 is a comparison curve diagram of the theoretical stress and simulation stress of three integral component models after deviation correction.

FIG. 11 is a schematic diagram of the geometric parameters of the integral component with a T-shaped cross-section composed of a substrate and an additive part.

### DETAILED DESCRIPTIONS OF EMBODIMENTS

The present application will be further described below with reference to the examples. The description of the following examples is only for helping understand the present application. It should be noted that for those of ordinary skill in the art, without departing from the principle of the present application, several modifications can also be made to the present application, and these improvements and modifications also fall within the protection scope of the claims of the present application.

### Example 1

With the continuous improvement of computer performance, three-dimensional transient thermal-mechanical coupling numerical models have gradually been applied to the simulation research of arc welding processes, and arc welding processes have certain similarities with wire arc additive manufacturing processes. Numerical models can be used as an effective supplementary tool for obtaining thermal-mechanical parameter information through actual wire arc additive manufacturing tests, and a large amount of data results that are difficult to obtain through tests can be obtained by expanding the parameter value range.

Therefore, it is crucial to develop an accurate and fast real-time simulation and model prediction method for multi-layer and multi-pass deposition stress by combining the thermal-mechanical theoretical model of wire arc additive manufacturing. In this regard, Example 1 of the present application provides a real-time simulation and model prediction method for wire arc additive manufacturing based on event sequences, which can realize real-time simulation of high-temperature and high-speed multi-layer and multi-pass deposition in wire arc additive manufacturing application scenarios, as well as efficient and accurate prediction of deposition stress and deformation.

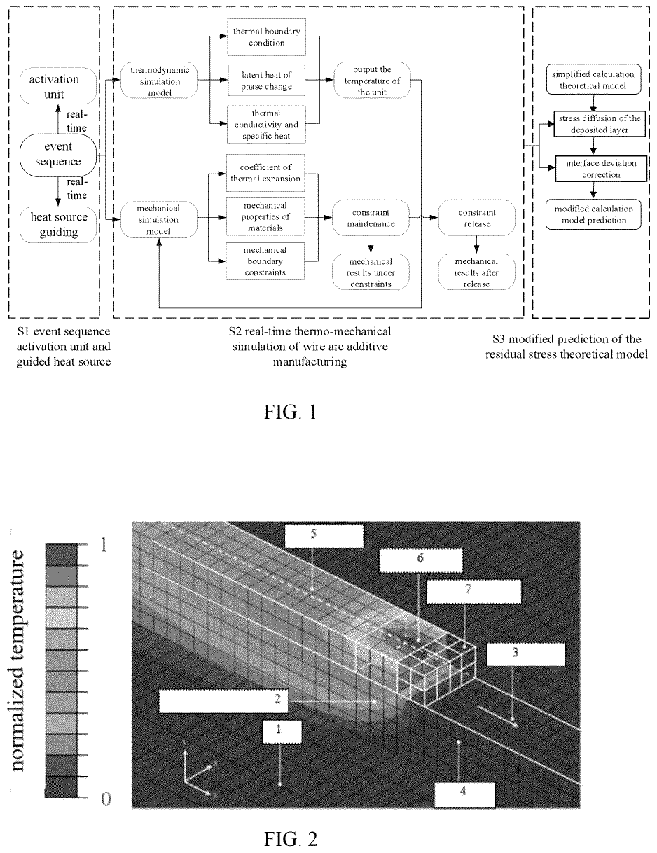

Specifically, as shown in FIG. 1, the method includes:
S1. in a real-time process of wire arc additive manufacturing of metal structures, activating elements in real time through event sequences and guiding a heat source in real time. The event sequences are used to define a three-dimensional field that changes with time and space, which is equivalent to setting a virtual cube to move in three-dimensional space along a preset path and time, and applying the influence of a three-dimensional field on the path passed by the virtual cube. Therefore, the event sequence method can be conveniently applied to the real-time simulation of the wire arc additive manufacturing process.
S1 includes:
S101. using the event sequences to restore the real-time process of wire arc additive manufacturing, and activating the elements on the path swept by the virtual cube of the event sequences one by one. The size of the virtual cube is definable, and the range interval of the elements to be activated is controlled thereby.

As shown in FIG. 2, during the real-time simulation, multi-layer printing and deposition of the WAAM additive part 2 are performed along the additive path 3 on the substrate 1. The completed deposition layer below is the previous layer 4, the deposition layer being printed above is the current layer 5, and the adjacent element in front of the position of the moving heat source 6 on the current layer 5 is the element to be activated 7. Since the temperature fields of different simulation models are different, the temperature field values can be normalized in the temperature field cloud diagram, with the highest temperature set to 1 and the lowest set to 0. In this example, the event sequence function module of ABAQUS software is used to perform real-time activation simulation of elements.
S102. taking a position of the virtual cube in the event sequences as a moving heat source position for guidance, and adopting a Goldak double ellipsoid heat source model, which does not require special writing of user subroutines, significantly reducing the construction workload of heat source model guidance.

Through S101 and S102, both the additive effect and heat source movement during the entire wire arc additive manufacturing process can be realized by using the event sequence method.

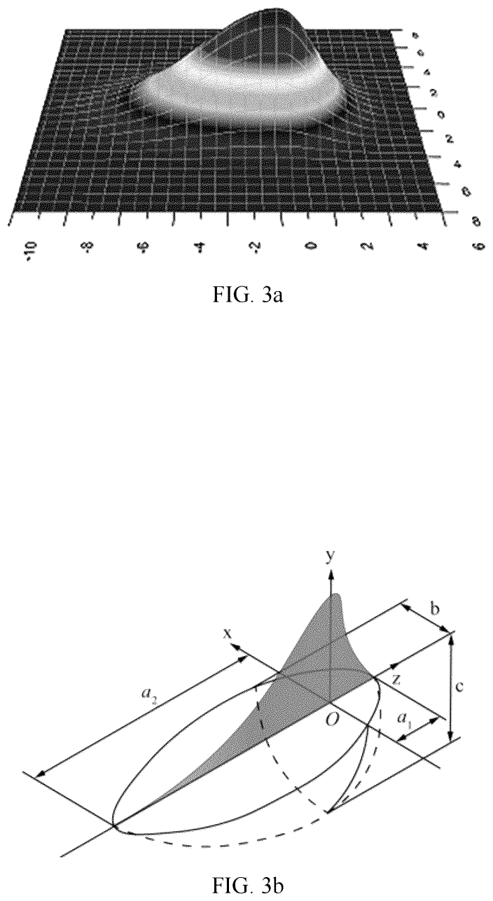

As shown in FIGS. 3a and 3b, the Goldak double ellipsoid heat source model is a volumetric heat source model considering laser penetration, which is accurate and practical when simulating the penetration phenomenon in the wire arc additive manufacturing process. In the Goldak double ellipsoid heat source model, the heat source is described in an asymmetric manner, and its power density follows a Gaussian distribution in the combined double ellipsoids. The temperature gradient in front of the heat source is much steeper than that at the trailing edge of the molten pool, and the power densities of the region in front of the arc center and the region behind the arc center are defined respectively.

The power density distribution q_{f} in the positive Z-axis quadrant is:

$${q}_{f} = \frac{6 \sqrt{3} {Qf}_{f}}{π \sqrt{π} {a}_{1} bc} {e}^{[ - 3 ( \frac{{x}^{2}}{{a}_{1}^{2}} + \frac{{y}^{2}}{{b}^{2}} + \frac{{z}^{2}}{{c}^{2}} ) ]} ; \qquad ( 1 )$$

The power density distribution qᵣ in the negative Z-axis quadrant is:

$${q}_{r} = \frac{6 \sqrt{3} {Qf}_{r}}{π \sqrt{π} {a}_{2} bc} {e}^{[ - 3 ( \frac{{x}^{2}}{{a}_{2}^{2}} + \frac{{y}^{2}}{{b}^{2}} + \frac{{z}^{2}}{{c}^{2}} ) ]} ; \qquad ( 2 )$$

wherein a₁ and a₂ are the lengths of the front ellipsoid and the rear ellipsoid respectively; b is the heat source width; c is the heat source depth; Q is the energy input considering efficiency factors; f_{f} and fᵣ are parameters for distributing the front and rear powers of the heat source, satisfying f_{f}+fᵣ=2.

As shown in FIG. 3b, in the Goldak double ellipsoid heat source model, different wire arc additive manufacturing processes can be simulated by adjusting model parameters, and the corresponding parameters of molten pool size and shape can be obtained. Parameters a₁, a₂, b, and c can be converted from cross-sectional metallographic data and molten pool surface ripple marks. Different parameter values represent the front and rear quadrant data of different molten pools to simulate different heat sources.
S2. setting heat source model parameters, thermal simulation parameters and mechanical simulation parameters based on an event sequence method in S1, and performing real-time thermal-mechanical simulation of wire arc additive manufacturing.
S2 includes:
S201. performing thermal simulation parameter setting and mechanical simulation parameter setting, and construct a thermal-mechanical coupling simulation model; wherein the thermal simulation parameter setting comprises a setting of thermal boundary conditions, latent heat of phase change, thermal conductivity and specific heat, and the mechanical simulation parameter setting comprises a setting of thermal expansion coefficient, material mechanical parameters and boundary mechanical constraints.

During the real-time simulation, the thermal simulation parameters to be set include thermal boundary conditions, latent heat of phase change, thermal conductivity, and specific heat, etc., and then the event sequence method is used to calculate the three-dimensional temperature field change in real time. Furthermore, when calculating the three-dimensional stress-strain field change in real time, the real-time three-dimensional temperature field result is input as a known condition, and the change curves of mechanical simulation parameters such as thermal expansion coefficient, material mechanical parameters, and boundary mechanical constraints that change with the temperature field are determined to calculate the three-dimensional stress-strain field results of the simulation model before and after the release of fixture constraints in real time.

In the wire arc additive manufacturing process, to control the deformation of the formed structural component, boundary mechanical constraints are applied to the structural component before the start of the additive manufacturing process. This constraint is usually achieved by installing fixtures on the substrate, and the fixture constraints are removed after the completion of cooling at the end of the additive manufacturing process. Meanwhile, the thermal conductivity, specific heat, thermal expansion coefficient, and material mechanical parameters (Young's modulus, Poisson's ratio, yield strength) of the formed structural component all change with the temperature field.

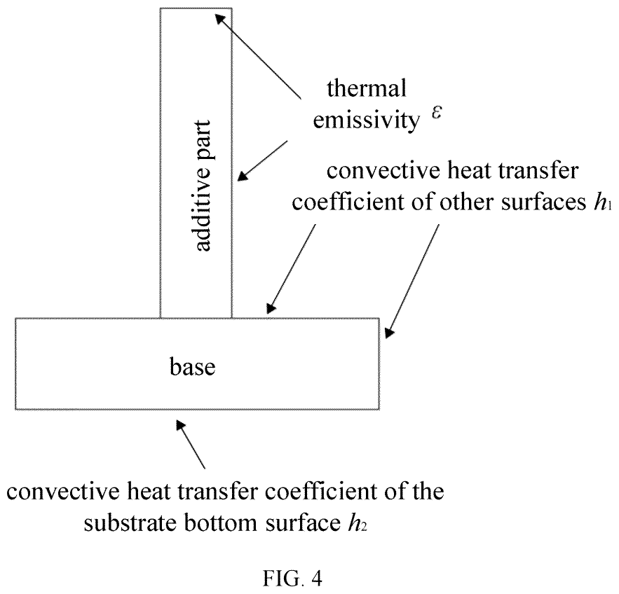

As shown in FIG. 4, in the setting of thermal boundary conditions for the integral component model with a T-shaped cross-section, the thermal emissivity of the surface of the integral component is set to e. The convective heat transfer coefficient of the surface of the additive part and the surface of the free part of the substrate is set to h₁, and the convective heat transfer coefficient of the bottom surface of the substrate is set to h₂. In this example, the thermal emissivity ε=0.2. The convective heat transfer coefficient h₁ of the surface of the additive part and the surface of the free part of the substrate is 5.7 W/(m²·K), and the convective heat transfer coefficient h₂ of the bottom surface of the substrate is 300 W/(m²·K).
S202. constructing a linear deposition simulation model to simulate a multi-layer and multi-pass deposition process of wire arc additive manufacturing, and obtaining a stress diffusion distribution of a deposited layer according to deposition stress simulation results.

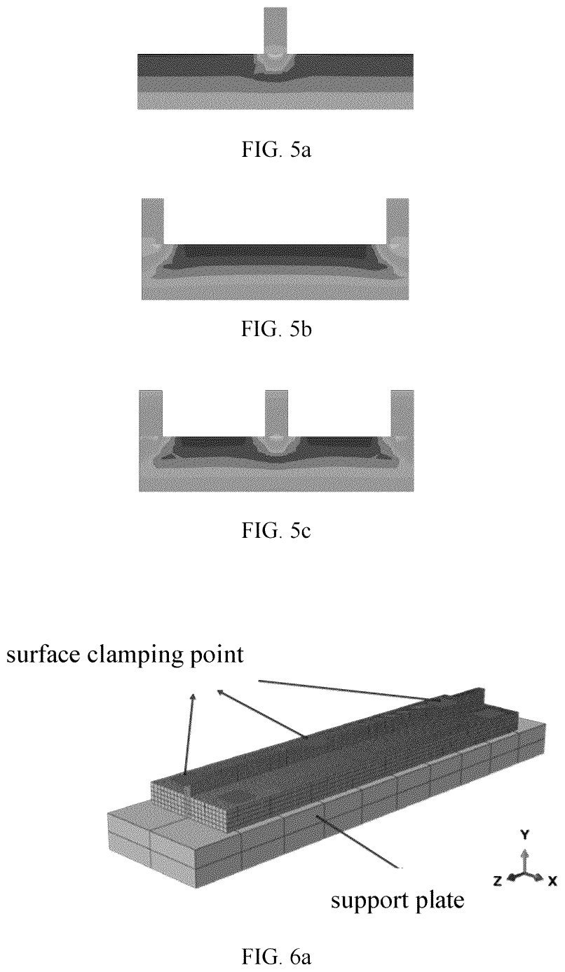

In S202, as shown in FIGS. 5a, 5b, and 5c, the linear deposition simulation model includes single-line, double-line, and three-line deposition simulation models. All three simulation models are set as additive parts with multi-layer and multi-pass deposition, and the geometric dimensions of the additive parts are the same. In the single-line deposition simulation model, the additive deposited layer is placed in the middle of the substrate. In the double-line deposition simulation model, the additive deposited layers are placed on the longitudinal edges on both sides of the substrate. In the three-line deposition simulation model, the additive deposited layers are placed on the longitudinal edges on both sides and the middle.

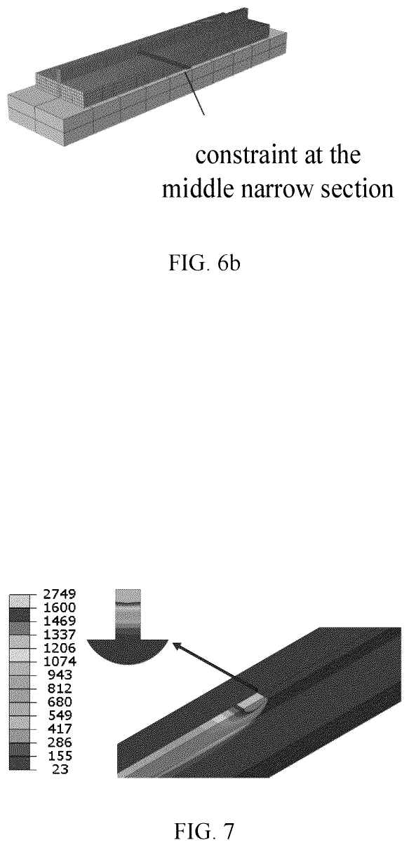

As shown in FIGS. 6a and 6b, all three simulation models adopt the same fixture constraint method and mesh division method. Taking the single-line deposition simulation model as an example, fixture constraints have a significant impact on the final deformation of single-line deposition. To effectively simulate the actual printing situation, a rigid support plate is added under the substrate, where the top surface of the support plate is the master surface and the bottom surface of the substrate is the slave surface, and rigid contact is adopted between them. This ensures that during the entire printing process, the integral component can only move along the positive Y-axis direction. In the actual operation process, the substrate also needs to be clamped to fix it on the printing platform. This condition is simulated by fixing the position of the red dot area on the upper surface of the substrate, and the fixture constraints are released at the end of the simulation process. Since the deformation of such simulation models is mostly warping deformation at both ends, while releasing the fixture constraints at the end, the narrow section elements in the middle of the substrate are selected and their displacements are constrained without constraining the rotation angles, thereby obtaining the stress and deformation results of the simulation model.

As shown in FIG. 7, in the wire arc additive manufacturing process, the inter-layer printing of the first layer with multiple passes is performed first, inter-layer cooling is carried out after the completion of the first layer printing, and then the printing of the second layer is performed, and so on. For the single-line deposition simulation model, the transient method in ABAQUS software is used to solve the temperature field and stress-strain field of the wire arc additive manufacturing process. In the actual printing process, the effect that only the temperature of the newly printed part reaches the melting point is achieved by controlling the temperature, which can effectively reduce the adverse impact on the forming quality caused by material collapse in additive manufacturing.
S3. establishing a simplified calculation theoretical model of a residual stress field based on a stress diffusion distribution and a correction deviation of a normal stress interface obtained from a real-time thermal-mechanical coupling simulation in S2, establishing a simplified calculation theoretical model of the residual stress field, and correcting a calculation model prediction.

### Example 2

On the basis of Example 1, Example 2 of the present application provides a more specific real-time simulation and model prediction method for wire arc additive manufacturing based on event sequences, including:
S1. in a real-time process of wire arc additive manufacturing of metal structures, activating elements in real time through event sequences and guiding a heat source in real time; wherein the event sequences are used to set a virtual cube to move in three-dimensional space along a preset path and time, and apply an influence of a three-dimensional field on the path passed by the virtual cube.
S2. setting heat source model parameters, thermal simulation parameters and mechanical simulation parameters based on an event sequence method in S1, and performing real-time thermal-mechanical simulation of wire arc additive manufacturing.
S3. establishing a simplified calculation theoretical model of a residual stress field based on a stress diffusion distribution and a correction deviation of a normal stress interface obtained from a real-time thermal-mechanical coupling simulation in S2, establishing a simplified calculation theoretical model of the residual stress field, and correcting a calculation model prediction.
S3 includes:
S301. establishing the simplified calculation theoretical model, which is composed of the substrate and an additive part in an wire arc additive manufacturing process, comprising a stress field distribution before a release of fixture constraints and a stress field distribution after the release of fixture constraints.

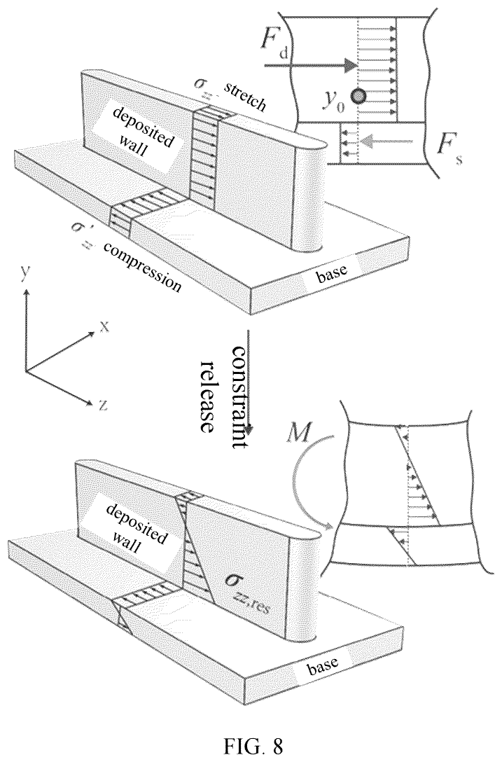

It should be noted that at the junction of the additive part and the substrate, there is a diffusion effect of deposition stress before and after the release of fixture constraints, which presents a semicircular shape. The present application analyzes the scenarios when the diffusion effect of deposition stress is not considered and when it is considered. S301 includes:
S3011. when the diffusion effect of deposition stress is not considered, the development and redistribution of the residual stress field remain unchanged along the longitudinal length L, and no edge effects are considered. As shown in FIG. 8, before releasing the fixture constraints on the substrate, there is deposition tensile stress generated during the wire arc additive manufacturing process on the deposited wall, and corresponding compressive stress is also generated on the substrate to balance it. It is assumed that the stresses on the substrate and the deposited wall are uniformly distributed in their respective parts, and there is a sudden change at the junction. The equivalent concentrated forces of the stresses on the substrate and the deposited wall are Fₛ and F_{d} respectively, acting at the respective centroid positions of the substrate and the wall, and there is a certain distance from the centroid height y₀ (neutral axis height) of the cross-section of the integral component.

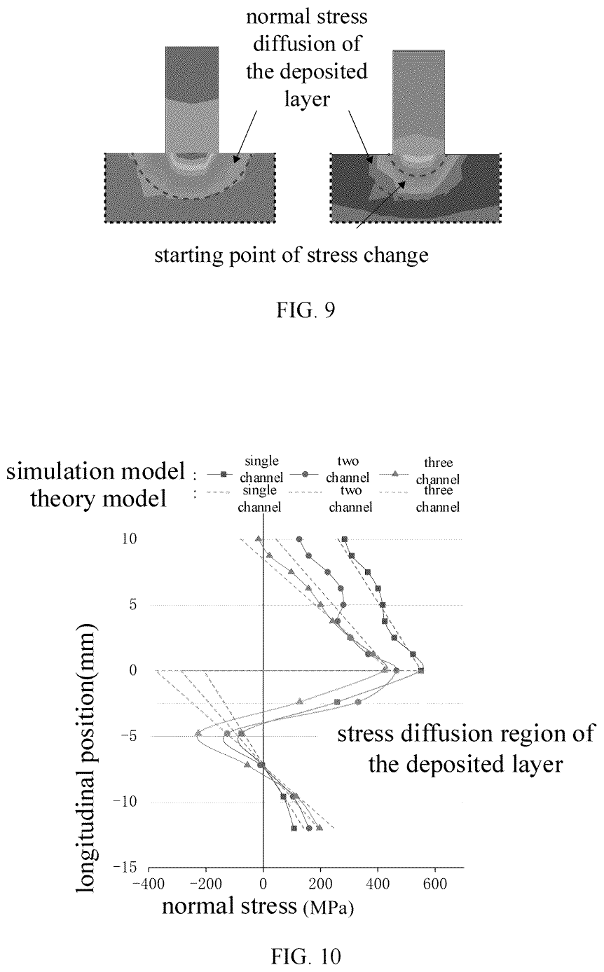

After releasing the fixture constraints on the substrate, the ends of the integral component are in a free state, the two equivalent concentrated forces are released and an internal bending moment M is generated, and the internal stress of the structure is redistributed to become the final residual stress of the component. The tensile stress above the neutral axis decreases linearly, if the height of the deposited wall is sufficient, compressive stress appears at the top of the deposited wall after stress redistribution.
S3012. when the diffusion effect of deposition stress is considered, as shown in FIG. 9, before the release of fixture constraints, the deposition normal stress is not limited to the deposited wall, but has a radial diffusion trend in the substrate part under the interface. This is because the substrate under the interface is close to the deposited layer and is also affected by thermal expansion and contraction, and this part is cyclically subjected to the secondary effect of heating-cooling-heating during the printing process, thereby also generating large deposition stress. Therefore, the deposition stress diffuses to the substrate, and the stress on the deposited wall and the substrate presents a roughly semicircular shape in the diffusion transition region, with a radius approximately equal to the deposition width. This diffusion effect still exists after the release of constraints.

In addition, as shown in FIGS. 9 and 10, the correction deviation Δy′ reflects the parallel curve deviation between the theoretical model result of the deposited layer and the simulation stress result after the release of fixture constraints, which can be obtained from the deposition layer stress diffusion distribution in the deposition simulation calculation result of step S2.2. The correction deviation Δy′ is mainly due to the diffusion effect of the deposited layer stress, so that after the release of fixture constraints, the starting point of the change of the normal stress of the deposited layer drops from the interface (i.e., the longitudinal position of 0) to a certain position on the substrate, where the stress before the release of fixture constraints is equal to the deposited layer stress. A schematic diagram of the comparison between the stress results of the corrected deposition simulation model and the theoretical model is drawn. The corrected theoretical model is closer to the simulation result and can more accurately predict the residual stress during the wire arc additive manufacturing process. In this example, the diffusion region is about 5 mm, and the Δy′ obtained through stress extraction and interpolation calculation is 2.55 mm.

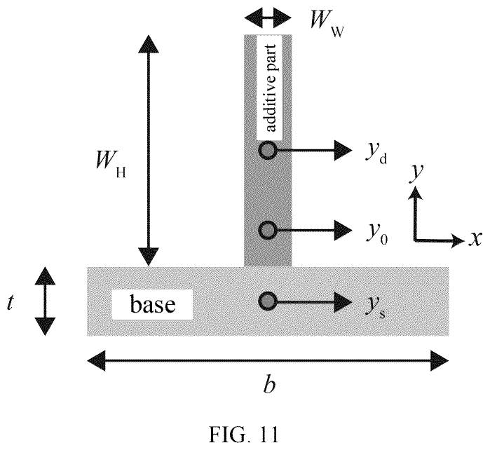

For different deposition models, the coordinates of the deviation position are also different, which are related to many factors such as model geometry, heat source parameters, and deposition materials. The correction deviation Δy′ of the residual stress can be observed and calculated from the deposition simulation model results.
S302. correcting the calculation model prediction, comprising:
S3021. As shown in FIG. 11, for the integral component with a T-shaped cross-section composed of the substrate and the additive part, calculate the centroid heights yₛ, y_{d}, and y₀ of the substrate, the deposited wall, and the integral component, with the calculation formulas as follows:

$${y}_{s} = t / 2 \qquad ( 3 )$$

$${y}_{d} = {W}_{H} / 2 + t \qquad ( 4 )$$

$${y}_{0} = \frac{\sum {y}_{s , i} \times {A}_{i}}{\sum {A}_{i}} = \frac{( {y}_{d} \times {W}_{W} \times {W}_{H} ) + ( {y}_{s} \times b \times t )}{{W}_{W} \times {W}_{H} + bt} \qquad ( 5 )$$

W_{W} is the width of the deposited wall, W_{H} is the height of the deposited wall, t is the thickness of the substrate, and b is the width of the substrate.
S3022. calculating the moment of inertia Iₓₓ of the T-shaped cross-section.

Specifically, the metal wire material used for the additive part is the same as that of the substrate. The centroid height y₀ of the integral component is also the position of the neutral axis of the T-shaped cross-section. The calculation formula for the moment of inertia Iₓₓ of the cross-section is:

$${I}_{xx} = \frac{( {bt}^{3} + {W}_{W} + {W}_{H}^{3} )}{12} + bt \times {( {y}_{0} - {y}_{s} )}^{2} + bt \times {( {y}_{0} - {y}_{s} )}^{2} + {W}_{W} \times {W}_{H} \times {( {y}_{d} - {y}_{0} )}^{2} \qquad ( 6 )$$

S3023. before the release of fixture constraints on the substrate, calculating the equivalent concentrated force F_{d} caused by the deposition stress σ_{zz} on the substrate during the wire arc additive manufacturing process and the pressure Fₛ in the substrate.

Specifically, before releasing the fixture constraints on the substrate, the equivalent concentrated force F_{d} caused by the deposition stress σ_{zz} on the substrate during the wire arc additive manufacturing process can be calculated by formula (7). The pressure Fₛ in the substrate shall satisfy Fₛ=F_{d} to ensure internal force balance.

$${F}_{d} = {F}_{s} = - \int \int {σ}_{zz} ( x , y ) \times dA ( {W}_{W} , {W}_{H} ) = {σ}_{zz} \times {W}_{W} \times {W}_{H} \qquad ( 7 )$$

Since it is assumed that the residual stresses of the substrate and the deposited wall are uniformly distributed on their respective rectangular cross-sections, the corresponding equivalent concentrated forces act at the centroids of their respective rectangular cross-sections, i.e., F_{d} and Fₛ act at the heights y_{d} and yₛ respectively.
S3024. before the release of fixture constraints on the substrate, calculate the bending moment M around the neutral axis generated by the positional offset between the equivalent concentrated force F_{d} and the pressure Fₛ in the substrate, with the calculation formula as follows:

$$M = {F}_{d} ( {y}_{d} - {y}_{0} ) + {F}_{s} ( {y}_{0} - {y}_{s} ) = F ( {y}_{d} - {y}_{s} ) = F ( t / 2 + {W}_{H} / 2 ) \qquad ( 8 )$$

S3025. after the release of fixture constraints on the substrate, calculating the deformation curvature κ of the calculation model.

Specifically, after the release of fixture constraints on the substrate, the deformation curvature of the model can be calculated by formula (9). In the formula, the parameters for calculating curvature are reclassified into two categories: material and deposition factor S determined by the deposition stress and material elastic modulus E, and geometric factor K determined by the geometric dimensions of the component.

$$κ [ \frac{1}{m} ] = \frac{1}{ρ} = \frac{M}{{EI}_{xx}} = \frac{\overbrace{{σ}_{zz}}^{material and deposition factor S}}{E} \times \frac{\overbrace{{W}_{W} \times {W}_{H} \times ( t + {W}_{H} )}^{geometric factor K}}{2 {I}_{xx}} = S [ \frac{MPa}{GPa} ] \times K [ \frac{1}{m} ] \qquad ( 9 )$$

Wherein κ is the deformation curvature, ρ is the radius of curvature, the unit of the material and deposition factor S is

$$[ \frac{MPa}{GPa} ] ,$$

and the unit of the geometric factor K is

$$[ \frac{1}{m} ] .$$

S3026. after the release of fixture constraints on the substrate, calculating the corrected residual stress field σ_{zz,res}(y) considering the normal stress interface correction deviation Δy′ during the entire wire arc additive manufacturing process.

After the release of fixture constraints on the substrate, the stress field is redistributed. The initial deposition stress field is superimposed with the stress caused by the bending moment M, and finally the corrected residual stress field σ_{zz,res}(y) considering the normal stress interface correction deviation Δy′ during the entire wire arc additive manufacturing process is obtained, which can be calculated by formula (10):

$${σ}_{zz , res} ( y ) = {σ}_{zz} + \frac{M}{{I}_{xx}} \times ( y - Δ {y}^{′} ) \qquad ( 10 )$$

Wherein y=0 is located at the height of the neutral axis y₀; Δy′ is the correction deviation of the normal stress interface caused by the stress diffusion of the deposited layer. The correction deviation is only applied to the part where the longitudinal stress is “positive”, i.e., the tensile stress zone, while the compressive stress zone of the substrate remains unchanged. For the same model, both M and Iₓₓ are constants in the y-direction, so the residual stress after the release of fixture constraints changes linearly along the y-axis direction.
S3027. calculating the descending gradient

$$\frac{{Δσ}_{zz}}{Δ y}$$

of the residual stress field, with the calculation formula as follows:

$$\frac{{Δσ}_{zz}}{Δ y} = \frac{M}{{I}_{xx}} \qquad ( 11 )$$

This example also demonstrates the analytical application of the real-time simulation and model prediction method for wire arc additive manufacturing based on event sequences in single-line, double-line, and three-line deposition models.

As shown in FIG. 11, the single-line deposition model has a relatively regular shape, with the following geometric dimensions: deposited wall height W_{H}=10 mm, width W_{W}=5 mm; substrate width b=60 mm, thickness t=12 mm; both deposition length and substrate length l=250 mm, deposition height h=2.5 mm, with a total of 4 deposited layers. The additive part of the model adopts cubic elements with a side length of 1.25 mm, and the substrate adopts cubic elements of 2.75×2.4×1.25 mm. The moving heat source speed is 4 mm/s, the inter-layer cooling time is 200 s, and the calculation ends 300 s after the completion of printing to ensure that the deposition model cools down to room temperature, with a total time of 1500 s. The dimensions of the double-line and three-line deposition models are the same as those of the single-line model, and the positions of the additive parts are as shown in FIG. 5.

According to formulas (3) to (11), the longitudinal stress descending gradients of the single-line, double-line, and three-line deposition models are calculated as

$$\frac{{Δσ}_{zz}}{Δ y} = 29.09 Mpa / mm ,$$

39.9 MPa/mm, and 50.5 MPa/mm respectively. The deposition layer stress diffusion distribution obtained by simulation calculation is as shown in FIG. 9.

Considering the diffusion effect of the deposited layer, according to the results shown in FIG. 9, the diffusion region is about 5 mm, and the correction deviation Δy′ obtained through stress extraction and interpolation calculation is 2.55 mm. Substituting it into formula (10), the residual stress distribution curve of the single-line deposition model is calculated as shown in FIG. 10.

It should be noted that the parts in this example that are the same as or similar to those in Example 1 can be referred to each other, and will not be repeated in the present application.

### Example 3

On the basis of Examples 1 and 2, Example 3 of the present application provides a real-time simulation and model prediction system for wire arc additive manufacturing based on event sequences, comprising:
an activation and guidance module, configured for in a real-time process of wire arc additive manufacturing of metal structures, activating elements in real time through event sequences and guiding a heat source in real time; wherein the event sequences are used to set a virtual cube to move in three-dimensional space along a preset path and time, and apply an influence of a three-dimensional field on the path passed by the virtual cube;
a simulation module, configured for inputting heat source model parameters, thermal simulation parameters and mechanical simulation parameters corresponding to the activation and guidance module, and performing real-time thermal-mechanical simulation of wire arc additive manufacturing; and
a prediction module, configured for inputting a stress diffusion distribution and a real-time thermal-mechanical coupling simulation obtained by the simulation module, and establishing a simplified calculation theoretical model, and correcting a calculation model prediction.

Specifically, the system provided in this example corresponds to the methods provided in Examples 1 and 2. Therefore, the parts in this example that are the same as or similar to those in Examples 1 and 2 can be referred to each other, and will not be repeated in the present application.

In summary, the real-time simulation and model prediction method for wire arc additive manufacturing based on event sequences provided by the present application realizes the simulation of high-temperature and high-speed multi-layer and multi-pass deposition in wire arc additive manufacturing application scenarios by activating elements and guiding the heat source through event sequences, obtains the stress diffusion effect caused by repeated thermal input at the junction of the additive part and the substrate of different materials through real-time thermal-mechanical simulation of wire arc additive manufacturing, and achieves efficient, real-time, and accurate prediction of deposition stress and deformation during the wire arc additive manufacturing process through the corrected prediction of the theoretical calculation of residual stress of the integral wire arc additive manufacturing component with a T-shaped cross-section considering the stress diffusion effect. Moreover, practical verification shows that the method of the present application is effective.

What is claimed is:

1. A real-time simulation and model prediction method for wire arc additive manufacturing based on event sequences, comprising:
S1. in a real-time process of wire arc additive manufacturing of metal structures, activating elements in real time through event sequences and guiding a heat source in real time; wherein the event sequences are used to set a virtual cube to move in three-dimensional space along a preset path and time, and apply an influence of a three-dimensional field on the path passed by the virtual cube;
S2. setting heat source model parameters, thermal simulation parameters and mechanical simulation parameters based on an event sequence method in S1, and performing real-time thermal-mechanical simulation of wire arc additive manufacturing; and
S3. establishing a simplified calculation theoretical model of a residual stress field based on a stress diffusion distribution and a correction deviation of a normal stress interface obtained from a real-time thermal-mechanical coupling simulation in S2, and correcting a calculation model prediction.

2. The real-time simulation and model prediction method for wire arc additive manufacturing based on event sequences according to claim 1, wherein S1 comprises:
S101. using the event sequences to restore the real-time process of wire arc additive manufacturing, and activating the elements on the path swept by the virtual cube of the event sequences one by one; and
S102. taking a position of the virtual cube in the event sequences as a moving heat source position for guidance, and adopting a Goldak double ellipsoid heat source model.

3. The real-time simulation and model prediction method for wire arc additive manufacturing based on event sequences according to claim 2, wherein S2 comprises:
S201. performing thermal simulation parameter setting and mechanical simulation parameter setting, and construct a thermal-mechanical coupling simulation model; wherein the thermal simulation parameter setting comprises a setting of thermal boundary conditions, latent heat of phase change, thermal conductivity and specific heat, and the mechanical simulation parameter setting comprises a setting of thermal expansion coefficient, material mechanical parameters and boundary mechanical constraints; and
S202. constructing a linear deposition simulation model to simulate a multi-layer and multi-pass deposition process of wire arc additive manufacturing, and obtaining a stress diffusion distribution of a deposited layer according to deposition stress simulation results.

4. The real-time simulation and model prediction method for wire arc additive manufacturing based on event sequences according to claim 3, wherein in S202, the linear deposition simulation model comprises a single-line deposition simulation model, a double-line deposition simulation model and a three-line deposition simulation model;
in the single-line deposition simulation model, an additive deposited layer is placed in a middle of a substrate;
in the double-line deposition simulation model, additive deposited layers are placed on longitudinal edges on both sides of the substrate; and
in the three-line deposition simulation model, additive deposited layers are placed on the longitudinal edges on both sides and a middle of the substrate.

5. The real-time simulation and model prediction method for wire arc additive manufacturing based on event sequences according to claim 4, wherein S3 comprises:
S301. establishing a simplified calculation theoretical model, which is composed of the substrate and an additive part in an wire arc additive manufacturing process, comprising a stress field distribution before a release of fixture constraints and a stress field distribution after the release of fixture constraints; at a junction of the additive part and the substrate, there is a diffusion effect of deposition stress before and after the release of fixture constraints, which presents a semicircular shape;
S302. correcting the calculation model prediction, comprising:
S3021. for an integral component with a T-shaped cross-section composed of the substrate and the additive part, calculating centroid heights yₛ, y_{d} and y₀ of the substrate, a deposited wall and an integral component;
S3022. calculating a moment of inertia Iₓₓ of a T-shaped cross-section;
S3023. before the release of fixture constraints on the substrate, calculating an equivalent concentrated force F_{d} caused by a deposition stress σ_{zz} on the substrate during the wire arc additive manufacturing process and a pressure Fₛ in the substrate;
S3024. before the release of fixture constraints on the substrate, calculating a bending moment M around a neutral axis generated by a positional offset between the equivalent concentrated force F_{d} and the pressure Fₛ in the substrate;
S3025. after the release of fixture constraints on the substrate, calculating a deformation curvature κ of the calculation model;
S3026. after the release of fixture constraints on the substrate, calculating a corrected residual stress field σ_{zz,res}(y) considering a normal stress interface correction deviation Δy′ during an entire wire arc additive manufacturing process;
$${σ}_{zz , res} ( y ) = {σ}_{zz} + \frac{M}{{I}_{xx}} \times ( y - Δ {y}^{′} ) ;$$
wherein y=0 is located at a height of the neutral axis y₀; Δy′ is a correction deviation of a normal stress interface caused by a stress diffusion of the deposited layer, and the correction deviation is only for a part where the longitudinal stress is “positive”, i.e., a tensile stress zone, while a compressive stress zone of the substrate remains unchanged;
S3027. calculating a descending gradient
$$\frac{{Δσ}_{zz}}{Δ y}$$
of the residual stress field.

6. A real-time simulation and model prediction system for wire arc additive manufacturing based on event sequences, for executing the method according to claim 1, comprising:
an activation and guidance module, configured for in a real-time process of wire arc additive manufacturing of metal structures, activating elements in real time through event sequences and guiding a heat source in real time; wherein the event sequences are used to set a virtual cube to move in three-dimensional space along a preset path and time, and apply an influence of a three-dimensional field on the path passed by the virtual cube;
a simulation module, configured for inputting heat source model parameters, thermal simulation parameters and mechanical simulation parameters corresponding to the activation and guidance module, and performing real-time thermal-mechanical simulation of wire arc additive manufacturing; and
a prediction module, configured for inputting a stress diffusion distribution and a real-time thermal-mechanical coupling simulation obtained by the simulation module, and establishing a simplified calculation theoretical model, and correcting a calculation model prediction.

7. A computer storage medium, wherein a computer program is stored in the computer storage medium; when the computer program is run on a computer, the computer is caused to execute the method according to claim 1.

8. An electronic device, comprising:
a memory, configured to store a computer program;
a processor, configured to execute the computer program to implement the method according to claim 1.
